(19) United States
(12) Patent Application Publication
(10) Pub. No.: US 2010/0053263 A1
(43) Pub. Date: Mar. 4, 2010

(54) DROPLET DISCHARGE DRAWING APPARATUS, DROPLET DISCHARGE DRAWING METHOD, AND DROPLET DISCHARGE DRAWING PROGRAM

(75) Inventors: Chiyoshi Yoshioka, Osaka (JP); Toshihiro Tamura, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/519,421

(22) PCT Filed: Dec. 18, 2007
(86) PCT No.: PCT/JP2007/074273

§ 371 Date: Nov. 19, 2009

(30) Foreign Application Priority Data
Dec. 27, 2006 (JP) 2006-353289

(51) Int. Cl. B41J 23/00

(52) U.S. Cl. 347/39

(57) ABSTRACT

A droplet discharge drawing apparatus of the present invention includes: an ink discharging section for discharging droplets to a plurality of targets of discharge present on a target recording material; a gantry sliding mechanism for relatively moving the ink discharging section with respect to the recording medium; and a pre-oscillation section for causing pre-oscillation of the droplet discharging section. The droplet discharge drawing apparatus further includes a control section supplying, to the pre-oscillation section, a pre-oscillation signal for causing the pre-oscillation of the ink discharging section so that the pre-oscillation is carried out before discharge of a droplet and within a time in which the displacement section moves the droplet discharging section relatively with respect to the target recording material. This provides a droplet discharge drawing apparatus which inhibits an increase in viscosity of the droplet during a time when the droplet discharging section moves so that (i) clogging of a nozzle or the like is prevented and (ii) a droplet made of, for example, ink is discharged at a high precision of landing.

### TECHNICAL FIELD

The present invention relates to a droplet discharge drawing apparatus, a droplet discharge drawing method, and a droplet discharge drawing program, in particular, to a droplet discharge drawing apparatus, a droplet discharge drawing method, and a droplet discharge drawing program each of which discharges droplets to a target recording material by use of droplet discharging means that moves relatively with respect to the target recording material.

### BACKGROUND ART

In recent years, it has been expected that an ink-jet technology will be applied to not only a printer for forming an image on a paper medium but also various fields, such as a field of a manufacturing apparatus.

For example, Patent Literature 1 discloses an arrangement of a manufacturing apparatus that includes an ink-jet type droplet discharging element. This manufacturing apparatus is disclosed as an apparatus for manufacturing a liquid crystal display, an organic EL display, a plasma display, an electron emitting element, or an electrophoretic display device, for example.

Patent Literature 1 further discloses a technique of inhibiting an increase in viscosity of ink and clogging of a nozzle in a droplet discharging head. In the technique, (i) a defective nozzle that cannot discharge ink properly is forced to discharge ink so as to remove clogged ink from the defective nozzle, and (ii) an opening portion of a non-defective nozzle is subjected to slight oscillation of a degree that does not cause the non-defective nozzle to discharge ink so that an increase in viscosity of ink is inhibited.

Furthermore, Patent Literatures 2 and 3 also disclose techniques for inhibiting an increase in viscosity of ink by causing a nozzle to be subjected to slight oscillation of a degree that does not cause the nozzle to discharge ink.

Patent Literature 2 discloses a technique of causing, after droplets are discharged from a discharging nozzle, the discharging nozzle to be subjected to slight oscillation depending on, for example, whether or not the discharging was carried out without any trouble. Moreover, Patent Literature 3 discloses a technique of inhibiting an increase in viscosity of ink, in which technique, when a voltage for discharging ink is applied to an ink discharging nozzle so as to cause the ink discharging nozzle to discharge ink, other ink discharging nozzles that are not used in the discharging are simultaneously subjected to oscillation of a degree that does not cause the ink discharging nozzles to discharge ink.

Patent Literatures 4 through 6 also disclose a basic arrangement of a technique related to oscillation that inhibits clogging of a nozzle (or the like) by causing the nozzle (or the like) to be subjected to the oscillation of a degree that does not cause the nozzle (or the like) to discharge ink.

Meanwhile, as one of applications to which the ink-jet technique is applied, a technique of repairing a defective color filter has been proposed. In the technique, if, for example, a section that has a defect in coloring is found on a color filter substrate in a step of manufacturing the color filter substrate, a color filter material is discharged only to such a defective section so as to repair the defective section (Patent Literature 7).

### Citation List

[Patent Literature 1]

Japanese Patent Application Publication, Tokukai, No. 2005-211711 A (Publication Date: Aug. 11, 2005).

[Patent Literature 2]

Japanese Patent Application Publication, Tokukai, No. 2004-291457 A (Publication Date: Oct. 21, 2004).

[Patent Literature 3]

Japanese Patent Application Publication, Tokukai, No. 2004-330524 A (Publication Date: Nov. 25, 2004).

[Patent Literature 4]

Japanese Patent Application Publication, Tokukaihei, No. 07-137252 A (Publication Date: May 30, 1995).

[Patent Literature 5]

Japanese Patent Application Publication, Tokukai, No. 2003-1857 A (Publication Date: Jan. 8, 2003).

[Patent Literature 6]

Japanese Patent Application Publication, Tokukai, No. 2003-175605 A (Jun. 24, 2003)

[Patent Literature 7]

Japanese Patent Application Publication, Tokukai, No. 2003-66218 A (Publication Date: Mar. 5, 2003).

### SUMMARY OF INVENTION

However, if the above conventional techniques of inhibiting an increase in viscosity of ink are applied to the technique (disclosed in Patent Literature 7) of repairing a color filter substrate, then increase in viscosity of ink cannot be sufficiently inhibited, and there still occur problems such as clogging of a nozzle or deterioration in precision of landing of ink. The following description deals with the reason why such problems occur.

In a case where the ink-jet technique is employed to repair, for example, a section defective in coloring on a color filter substrate, it is necessary to efficiently discharge ink, at a high precision, to the section to be repaired on the color filter substrate.

The sections to be repaired are often scattered on the color filter substrate. Accordingly, ink discharging means is required to move above the color filter substrate while the ink discharging means does not discharge ink. Even when there is only one section to be repaired, the ink discharging means still needs to move to the section to be repaired.

Generally, the ink discharging means has a nozzle for discharging ink. The ink discharging means moves, having the nozzle open. Therefore, ink with which the nozzle is filled tends to volatilize during the movement. This often causes an increase in viscosity of ink.

Particularly, in recent years, larger color filter substrates have been manufactured. In order to repair such a large color filter substrate, the discharging means is required to move a long distance. Because of this, an increase in viscosity of ink becomes more influential during the movement of the discharging means, and a problem such as clogging of a nozzle becomes more serious.

Further, in a case where a plurality of discharging means are provided, the plurality of discharging means are not always used equally. Accordingly, each discharging means has different tendency of increasing the viscosity of ink with which a nozzle is filled. Particularly, discharging means that less frequently discharges ink moves a long distance between positions where the discharging means discharges ink. This tends to increase the viscosity of the ink with which the discharging means is filled, and, consequently, tends to cause the clogging of the nozzle and deterioration in precision of landing of ink.

Further, in order to reduce a time for carrying out the repair process, the discharging means is required to move faster. However, the faster the discharging means moves, the faster the ink with which the discharging means is filled dries. This causes the ink to easily have an increase in viscosity.

Therefore, in a case where the ink-jet technology is applied to repair of a color filter substrate, the technology is required to inhibit, before discharge of ink by the discharging means, an increase in viscosity of ink which increase occurs while the discharging means moves from a position where the discharging means discharges ink to a position where the discharging means is to discharge ink next.

However, the both techniques disclosed in Patent Literatures 1 and 2 are such that, after printing is carried out, the problem of the increase in viscosity of ink is solved by, for example, subjecting a discharging head or the like that has not discharged ink properly to slight oscillation. Such techniques cannot inhibit, in advance, the increase in viscosity of ink which increase occurs during movement of the discharging means for discharging ink or the like.

Further, in the technique disclosed in Patent Literature 3, as described above, when a voltage for discharging ink is applied to an ink nozzle for discharging ink, other ink nozzles that are not used for the discharge of ink are subjected to oscillation of a degree that the ink is not discharged. That is, the ink nozzles that are not used for the discharge of ink are not subjected to oscillation unless any of the ink nozzles discharges ink. According to this technique, it is not possible to sufficiently inhibit the increase in viscosity of ink during the movement of the discharging means.

In a case of the repair of a color filter substrate, in particular, viscosity of ink may increase while the discharging means moves to a position where the discharging means discharges, for the first time, ink to a color filter substrate to be repaired. Further, even in a case where one discharging means discharges ink sequentially, the discharging means may move a long distance. Furthermore, even if any of the discharging means discharges ink and simultaneously the other discharging means are subjected to oscillation, the other discharging means may move a longer distance before discharging ink. As described above, with the technique disclosed in Patent Literature 3, it is impossible to inhibit an increase in viscosity of ink unless any of the ink nozzles discharges ink. Accordingly, it is impossible to inhibit viscosity of ink from being increased in the cases as described above.

Patent Literatures 4 through 6 merely disclose techniques for causing a nozzle to oscillate, and do not disclose anything about the problem of an increase in viscosity of ink during the movement of the discharging means for discharging ink or the like. Such techniques do not contribute to inhibition of an increase in viscosity of ink during the movement of the discharging means for discharging ink or the like.

Meanwhile, demands for efficient discharge of droplets to a desired sections will grow not only in repairing a color filter substrate but also in various manufacturing fields.

As described above, there has been a demand for development of an apparatus that is capable of (i) inhibiting clogging of a nozzle, and (ii) discharging droplets to desired sections with high precision.

The present invention is attained in view of the above problems. An object of the present invention is to provide, by inhibiting an increase in viscosity of droplets during the movement of the discharging means, a droplet discharge drawing apparatus which, even when discharge means is moved at a high speed, prevents clogging of a nozzle or the like and discharges by an ink-jet method droplets made of, for example, ink or the like at a high precision of landing of the droplets on a plurality of desired positions on a target recording material.

In order to solve the problems described above, a droplet discharge drawing apparatus includes: droplet discharging means that discharges droplets with respect to a plurality of targets of discharge present on a target recording material; displacement means that relatively moves the droplet discharging means with respect to the target recording material; pre-oscillation means that causes pre-oscillation of the droplet discharging means; and control means supplying an oscillation signal to the pre-oscillation means so that the pre-oscillation is carried out before discharge of a droplet by the droplet discharging means and within a time in which the displacement means relatively moves the droplet discharging means with respect to the target recording material, the pre-oscillation signal being for causing the pre-oscillation of the pre-oscillation means.

According to the configuration, while the droplet discharging means moves to a position that allows a droplet to be discharged to a target of discharge, it is possible to cause pre-oscillation of the droplet discharging means. Accordingly, an increase in viscosity of the ink filled in the droplet discharging means is prevented and, in addition, the ink can be discharged to the target of discharge.

Therefore, it becomes possible to provide a droplet discharge drawing apparatus that inhibits an increase in viscosity of droplets such as ink during the movement of the droplet discharging means so that (i) clogging of the nozzle or the like hardly occurs even if the discharging means is moved at a high speed and (ii) the droplets can be discharged to a plurality of desired points on the target recording material at a high precision of landing.

In the droplet discharge drawing apparatus of the present invention, it if preferable that: the displacement means relatively moves, at a constant speed in a main scanning direction, the droplet discharging means with respect to the target recording material; and the droplet discharging means is movable in a sub scanning direction intersecting with the main scanning direction.

Because the droplet discharging means is movable in the scanning direction and the sub scanning direction, the present invention further provides an advantage such that a droplet can be effectively discharged to a desired point on a large-size target recording material.

In the droplet discharge drawing apparatus of the present invention, it is preferable that: the control means supplies the oscillation signal to the pre-oscillation means, while the displacement means moves the droplet discharging means from a position where a droplet is previously discharged to a position which allows a droplet to be discharged next to a target of discharge, the oscillation signal being for causing the pre-oscillation of the droplet discharging means.

The pre-oscillation of the droplet discharging means is carried out during movement of the droplet discharging means between targets of discharge. This further provides an advantage such that an increase in viscosity of the droplet can be prevented during the movement.

In the droplet discharge drawing apparatus of the present invention, it is preferable that: the control means supplies the oscillation signal to the pre-oscillation means, before the droplet discharging means first reaches a position allowing a droplet to be discharged on a target of discharge after the displacement means starts to move the droplet discharging means, the oscillation signal being for causing the pre-oscillation of the droplet discharging means.

After the droplet discharging means starts to move, pre-oscillation is carried out before the droplet discharging means first discharges the ink. This further provides an advantage such that an increase in viscosity of the ink can be prevented in the first movement.

In the droplet discharge drawing apparatus of the present invention, it is preferable that: the control means supplies, to the pre-oscillation means, the oscillation signal for causing the pre-oscillation of the droplet discharging means, the pre-oscillation signal indicating (i) a number of times of oscillation in the pre-oscillation in a range of not less than 1000 but not more than 10000 and (ii) a period for one time of the oscillation in a range of 0.000005 second to 0.0001 second.

Because the pre-oscillation of the droplet discharging means is carried out the number of times of oscillation and at the period of the oscillation as described above, it becomes possible to sufficiently prevent an increase in viscosity of the droplet during the movement of the droplet discharging means. Therefore, clogging of a nozzle or the like is prevented and, in addition, an improved precision of landing of the droplet can be obtained.

In the droplet discharge drawing apparatus of the present invention, it is preferable that: the control means is capable of changing a pre-oscillation time required for carrying out the pre-oscillation, in accordance with at least one of: a movement time required for moving the droplet discharging means to a position which first allows the droplet discharging means to discharge a droplet to a target of discharge, after the displacement means starts to move the droplet discharging means; and a movement time required for moving the droplet discharging means from a position where a droplet is previously discharged to a position where a droplet is to be discharged next to another target of discharge.

Because the pre-oscillation time can be varied, timing of the pre-oscillation of the droplet discharging means can be controlled by a desired condition. This further provides an effect of providing a droplet discharge drawing apparatus capable of providing a desired precision of landing of the droplet.

The droplet discharge drawing apparatus of the present invention further includes: pre-oscillation condition input means through which an oscillation condition is inputted for the pre-oscillation that the droplet discharging means is caused to carry out, the control means calculating: at least one of: a movement time required for moving the droplet discharging means to a position which first allows the droplet discharging means to discharge a droplet to a target of discharge, after the displacement means starts to move the droplet discharging means; and a movement time required for moving the droplet discharging means from a position where a droplet is previously discharged to a position where a droplet is to be discharged next to another target of discharge; and a pre-oscillation time required for allowing the droplet discharging means to carry out the pre-oscillation that satisfies the oscillation condition.

Because it is possible to precisely figure out the movement time and pre-oscillation time of the droplet discharging means, pre-oscillation of the droplet discharging means can be carried out under a desired condition based on the movement time and pre-oscillation time. This further provides an effect of providing a droplet discharge drawing apparatus for which a desired precision of landing of the droplet can be set depending on a purpose.

In the droplet discharge drawing apparatus of the present invention, it is preferable that: if the movement time calculated for the droplet discharging means is longer than twice the pre-oscillation time calculated for the droplet discharging means, the control means supplies the pre-oscillation signal to the pre-oscillation means so that, when a period equal to a half of the movement time passes after start of the movement time, the droplet discharging means starts the pre-oscillation, the pre-oscillation signal being for causing the pre-oscillation of the droplet discharging means.

The pre-oscillation of the droplet discharging means is carried out in a latter half of the movement before the discharge of the droplet. Accordingly, the droplet can be discharged after the problem of the increase in viscosity of the droplet caused in movement before the pre-oscillation is resolved. This can further provides effects such that clogging of a nozzle or the like is more effectively prevented and the droplet is discharged at a higher precision of landing of the droplet.

In the droplet discharge drawing apparatus of the present invention, it is preferable that: if the movement time calculated for the droplet discharging means is longer than the pre-oscillation time calculated for the droplet discharging means, the control means supplies the pre-oscillation signal to the pre-oscillation means so that, at the time when the pre-oscillation time ends, the droplet discharging means starts discharge of a droplet, the pre-oscillation signal being for causing the pre-oscillation of the droplet discharging means.

Because the pre-oscillation of the droplet discharging means is carried out right before the discharge of the droplet, the droplet can be discharged after the problem of the increase in viscosity of the droplet caused in movement before the pre-oscillation is resolved. This can further provides effects such that clogging of a nozzle or the like is more effectively prevented and the droplet is discharged at a higher precision of landing of the droplet.

In the droplet discharge drawing apparatus of the present invention, it is preferable that: when the movement time calculated for the droplet discharging means is shorter than the pre-oscillation time calculated for the droplet discharging means, the pre-oscillation condition input means allows an input of the pre-oscillation time in a range of 1/10 to 1 times as long as the movement time, the pre-oscillation time being for causing the pre-oscillation of the droplet discharging means; and the control means supplies, to the pre-oscillation means, the pre-oscillation signal in accordance with the setting.

A time of the actual pre-oscillation of the droplet discharging means is shortened so that the pre-oscillation can be carried out within the movement time. Accordingly, even when the droplet discharging means moves between targets of discharge close to each other, the pre-oscillation of the droplet discharging means can be carried out. This can further provides effects such that clogging of a nozzle or the like is more effectively prevented and the droplet is discharged at a higher precision of landing of the droplet.

In the droplet discharge drawing apparatus of the present invention, it is preferable that: in a case where: at least one of the movement times calculated for the droplet discharging means is longer than the pre-oscillation time calculated for the droplet discharging means; and there is the movement time that is calculated for the droplet discharging means and shorter than the pre-oscillation time of the droplet discharging means, the control means does not supply the pre-oscillation signal to the pre-oscillation means so that the droplet discharging means that moves for the movement time shorter than the pre-oscillation time does not carry out the pre-oscillation.

If a desired pre-oscillation is impossible within the movement time, the pre-oscillation is omitted. This makes it possible to omit pre-oscillation that provides a less effect because the pre-oscillation time is too short. Therefore, by omitting a step providing a less effect, it becomes possible to carry out discharge of the droplet more effectively.

The droplet discharge drawing apparatus of the present invention further includes: a plurality of droplet discharging means each being filled with a different kind of droplets.

The pre-oscillation of each of the plurality of droplet discharging means can be carried out while a time when each of the plurality of droplet discharging means moves. This makes it possible to provide a droplet discharge drawing apparatus capable of discharging a plurality of droplets at a high precision of landing.

In the droplet discharge drawing apparatus of the present invention, it is preferable that: the control means supplies the pre-oscillation signal to each of the plurality of droplet discharging means so that the plurality of droplet discharging means take an identical time from an end of the pre-oscillation carried out by each of the plurality of droplet discharging means to a start of discharge of a droplet by each of the plurality of droplet discharging means having carried out the pre-oscillation, the pre-oscillation signal being for causing the pre-oscillation of each of the plurality of droplet discharging means.

Because each droplet discharging means is arranged to have the same length of time from the pre-oscillation to discharge of the droplet, each droplet discharging means can provide the same precision of landing of the droplet. Therefore, it becomes possible to provide a droplet discharge drawing apparatus that does not cause a difference in precision of landing of droplet depending on types of droplets or the order of discharge and that has a steady precision of landing of droplet.

In the droplet discharge drawing apparatus of the present invention, it is preferable that: the target recording material is a color filter panel for a liquid crystal display apparatus; and the targets of discharge are defective pixels that occur on the color filter panel for the liquid crystal display apparatus.

This further makes it possible to provide a droplet discharge drawing apparatus capable of producing a good quality color filter panel for a liquid crystal display apparatus by repairing defective pixels that occur on the color filter panel for the liquid crystal display apparatus.

In order to solve the problems described above, a droplet discharge drawing method of the present invention includes the steps of: discharging, by use of droplet discharging means, droplets with respect to a plurality of targets of discharge present on a target recording material; relatively moving the droplet discharging means with respect to the target recording material; causing, by use of pre-oscillation means, pre-oscillation of the droplet discharging means; and controlling by supplying an oscillation signal to the pre-oscillation means so that the pre-oscillation is carried out before discharge of a droplet by the droplet discharging means and within a time in which the displacement means relatively moves the droplet discharging means with respect to the target recording material, the oscillation signal being for causing the pre-oscillation of the pre-oscillation means.

According to the configuration, while the droplet discharging means moves to a position that allows a droplet to be discharged to a target of discharge, it is possible to cause pre-oscillation of the droplet discharging means. Accordingly, an increase in viscosity of the ink filled in the droplet discharging means is prevented and, in addition, the ink can be discharged to the target of discharge.

Therefore, it becomes possible to provide a droplet discharge drawing method that inhibits an increase in viscosity of droplets such as ink during the movement of the droplet discharging means so that (i) clogging of the nozzle or the like hardly occurs even if the discharging means is moved at a high speed and (ii) the droplets can be discharged to a plurality of desired points on the target recording material at a high precision of landing.

The droplet discharge drawing method of the present invention preferably further includes the step of: moving the droplet discharging means in a sub scanning direction intersecting with a main scanning direction, wherein, in the step of moving, the droplet discharging means is relatively moved with respect to the target recording material at a constant speed in the main scanning direction.

Because the droplet discharging means is movable in the scanning direction and the sub scanning direction, the present invention further provides an advantage such that a droplet can be effectively discharged to a desired point on a large-size target recording material.

In the droplet discharge drawing method of the present invention, it is preferable that: the step of controlling includes the sub-step of supplying the oscillation signal to the pre-oscillation means, while, in the step of moving, the droplet discharging means is moved from a position where a droplet is previously discharged to a position which allows a droplet to be discharged next to a target of discharge, the oscillation signal being for causing the pre-oscillation of the droplet discharging means.

The pre-oscillation of the droplet discharging means is carried out during movement of the droplet discharging means between targets of discharge. This further provides an advantage such that an increase in viscosity of the droplet can be prevented during the movement.

In the droplet discharge drawing method of the present invention, it is preferable that: the step of controlling includes the sub-step of supplying the oscillation signal to the pre-oscillation means, before the droplet discharging means first reaches a position allowing a droplet to be discharged on a target of discharge after the droplet discharging means starts to move in the step of moving, the oscillation signal being for causing the pre-oscillation of the droplet discharging means.

After the droplet discharging means starts to move, pre-oscillation is carried out before the droplet discharging means first discharges the ink. This further provides an advantage such that an increase in viscosity of the ink can be prevented in the first movement.

In the droplet discharge drawing method of the present invention, it is preferable that: the step of controlling includes the sub-step of supplying, to the pre-oscillation means, the oscillation signal for causing the pre-oscillation of the droplet discharging means, the pre-oscillation signal indicating (i) a number of times of oscillation in the pre-oscillation in a range of not less than 1000 but not more than 10000 and (ii) a period for one time of the oscillation in a range of 0.000005 second to 0.0001 second.

Because the pre-oscillation of the droplet discharging means is carried out the number of times of oscillation and at the period of the oscillation as described above, it becomes possible to sufficiently prevent an increase in viscosity of the droplet during the movement of the droplet discharging means. Therefore, clogging of a nozzle or the like is prevented and, in addition, an improved precision of landing of the droplet can be obtained.

In the droplet discharge drawing method of the present invention, it is preferable that: the step of controlling includes the sub-step of changing a pre-oscillation time required for carrying out the pre-oscillation, in accordance with at least one of: a movement time required, in the step of moving, for moving the droplet discharging means to a position which first allows the droplet discharging means to discharge a droplet to a target of discharge, after the droplet discharging means starts to move; and a movement time required, in the step of moving, for moving the droplet discharging means from a position where a droplet is previously discharged to a position where a droplet is to be discharged next to another target of discharge.

Because the pre-oscillation time can be varied, timing of the pre-oscillation of the droplet discharging means can be controlled by a desired condition. This further provides an effect of providing a droplet discharge drawing apparatus capable of providing a desired precision of landing of the droplet.

The droplet discharge drawing method of the present invention further includes the step of: inputting a pre-oscillation condition for inputting an oscillation condition of the pre-oscillation that the droplet discharging means is caused to carry out, the step of controlling including the sub-steps of: calculating at least one of: a movement time required for moving the droplet discharging means to a position which first allows the droplet discharging means to discharge a droplet to a target of discharge, after the displacement means starts to move the droplet discharging means; and a movement time required for moving the droplet discharging means from a position where a droplet is previously discharged to a position where a droplet is to be discharged next to another target of discharge; and calculating a pre-oscillation time required for allowing the droplet discharging means to carry out the pre-oscillation that satisfies the oscillation condition.

Because it is possible to precisely figure out the movement time and pre-oscillation time of the droplet discharging means, pre-oscillation of the droplet discharging means can be carried out under a desired condition based on the movement time and pre-oscillation time. This further provides an effect such that a desired precision of landing of the droplet can be set depending on a purpose.

In the droplet discharge drawing method of the present invention, it is preferable that: if the movement time calculated for the droplet discharging means is longer than twice the pre-oscillation time calculated for the droplet discharging means, the step of controlling includes the sub-step of supplying the pre-oscillation signal to the pre-oscillation means so that, when a period equal to a half of the movement time passes after start of the movement time, the droplet discharging means starts the pre-oscillation, the pre-oscillation signal being for causing the pre-oscillation of the droplet discharging means.

The pre-oscillation of the droplet discharging means is carried out in a latter half of the movement before the discharge of the droplet. Accordingly, the droplet can be discharged after the problem of the increase in viscosity of the droplet caused in movement before the pre-oscillation is resolved. This can further provides effects such that clogging of a nozzle or the like is more effectively prevented and the droplet is discharged at a higher precision of landing of the droplet.

In the droplet discharge drawing method of the present invention, it is preferable that: if the movement time calculated for the droplet discharging means is longer than the pre-oscillation time calculated for the droplet discharging means, the step of controlling includes the sub-step of supplying the pre-oscillation signal to the pre-oscillation means so that, at the time when the pre-oscillation time ends, the droplet discharging means starts discharge of a droplet, the pre-oscillation signal being for causing the pre-oscillation of the droplet discharging means.

Because the pre-oscillation of the droplet discharging means is carried out right before the discharge of the droplet, the droplet can be discharged after the problem of the increase in viscosity of the droplet caused in movement before the pre-oscillation is resolved. This can further provides effects such that clogging of a nozzle or the like is more effectively prevented and the droplet is discharged at a higher precision of landing of the droplet.

In the droplet discharge drawing method of the present invention, it is preferable that: when the movement time calculated for the droplet discharging means is shorter than the pre-oscillation time calculated for the droplet discharging means, the step of inputting the pre-oscillation condition includes the sub-step of inputting the pre-oscillation time in a range of 1/10 to 1 times as long as the movement time, the pre-oscillation time being for causing the pre-oscillation of the droplet discharging means; and the step of controlling includes the sub-step of supplying, to the pre-oscillation means, the pre-oscillation signal in accordance with the setting.

A time of the actual pre-oscillation of the droplet discharging means is shortened so that the pre-oscillation can be carried out within the movement time. Accordingly, even when the droplet discharging means moves between targets of discharge close to each other, the pre-oscillation of the droplet discharging means can be carried out. This can further provides effects such that clogging of a nozzle or the like is more effectively prevented and the droplet is discharged at a higher precision of landing of the droplet.

In the droplet discharge drawing method of the present invention, it is preferable that: in a case where: at least one of the movement times calculated for the droplet discharging means is longer than the pre-oscillation time calculated for the droplet discharging means; and there is the movement time that is calculated for the droplet discharging means and shorter than the pre-oscillation time of the droplet discharging means, in the step of controlling, the pre-oscillation signal is not supplied to the pre-oscillation means so that the droplet discharging means that moves for the movement time shorter than the pre-oscillation time does not carry out the pre-oscillation.

If a desired pre-oscillation is impossible within the movement time, the pre-oscillation is omitted. This makes it possible to omit pre-oscillation that provides a less effect because the pre-oscillation time is too short. Therefore, by omitting a step providing a less effect, it becomes possible to carry out discharge of the droplet more effectively.

In the droplet discharge drawing method of the present invention, it is preferable to use the droplet discharge drawing apparatus including a plurality of droplet discharging means each being filled with a different kind of droplets.

The pre-oscillation of each of the plurality of droplet discharging means can be carried out while a time when each of the plurality of droplet discharging means moves. This makes it possible to provide a droplet drawing method capable of discharging a plurality of droplets at a high precision of landing.

In the droplet discharge drawing method of the present invention, it is preferable that: the step of controlling includes the sub-step of supplying the pre-oscillation signal to each of the plurality of droplet discharging means so that the plurality of droplet discharging means take an identical time from an end of the pre-oscillation carried out by each of the plurality of droplet discharging means to a start of discharge of a droplet by each of the plurality of droplet discharging means having carried out the pre-oscillation, the pre-oscillation signal being for causing the pre-oscillation of each of the plurality of droplet discharging means.

Because each droplet discharging means is arranged to have the same length of time from the pre-oscillation to discharge of the droplet, each droplet discharging means can provide the same precision of landing of the droplet. Therefore, it becomes possible to provide a droplet discharge drawing method that does not cause a difference in precision of landing of droplet depending on types of droplets or the order of discharge and that has a steady precision of landing of droplet.

In the droplet discharge drawing method of the present invention, it is preferable that: a color filter panel for a liquid crystal display apparatus is used as the target recording material; and the targets of discharge are defective pixels that occur on the color filter panel for the liquid crystal display apparatus.

This makes it possible to provide a droplet discharge drawing method that makes it possible to produce a good quality color filter panel for a liquid crystal display apparatus by repairing defective pixels that occur on the color filter panel for the liquid crystal display apparatus.

In order to solve the problems described above, a droplet discharge drawing program of the present invention causes control means to function as means supplying an oscillation signal to pre-oscillation means so that pre-oscillation is carried out before discharge of droplets by droplet discharging means and within a time in which displacement means relatively moves the droplet discharging means with respect to a target recording material, the pre-oscillation signal being for causing the pre-oscillation of the droplet discharging means, the control means supplying the pre-oscillation signal to the pre-oscillation means, the control means being provided in a droplet discharge drawing apparatus including: the droplet discharging means that discharges droplets with respect to a plurality of targets of discharge present on the target recording material; the displacement means that relatively moves the droplet discharging means with respect to the target recording material; and the pre-oscillation means that causes the pre-oscillation of the droplet discharging means.

According to the configuration, while the droplet discharging means moves to a position that allows a droplet to be discharged to a target of discharge, it is possible to cause pre-oscillation of the droplet discharging means. Accordingly, an increase in viscosity of the ink filled in the droplet discharging means is prevented and, in addition, it becomes possible to cause the ink to be discharged to the target of discharge.

Therefore, it becomes possible to provide a droplet discharge drawing program for controlling a droplet discharge drawing apparatus that inhibits an increase in viscosity of droplets such as ink during the movement of the ink discharging means so that (i) clogging of the nozzle or the like hardly occurs even if the discharging means is moved at a high speed and (ii) the droplets such as ink can be discharged to a plurality of desired points on the target recording material at a high precision of landing.

In order to solve the problem described above, a droplet discharge drawing program of the present invention causes control means to function as means supplying an oscillation signal to pre-oscillation means so that pre-oscillation is carried out before discharge of droplets by droplet discharging means and within a time in which displacement means relatively moves the droplet discharging means with respect to a target recording material, the pre-oscillation signal being for causing the pre-oscillation of the droplet discharging means, the control means supplying the pre-oscillation signal to the pre-oscillation means, the control means being provided in a droplet discharge drawing apparatus including: the droplet discharging means that discharges droplets with respect to a plurality of targets of discharge present on the target recording material, the droplet discharging means being movable in a sub scanning direction intersecting with a main scanning direction; the displacement means that relatively moves, at a constant speed in the main scanning direction, the droplet discharging means with respect to the target recording material; and the pre-oscillation means that causes the pre-oscillation of the droplet discharging means.

Because the droplet discharging means is movable in the scanning direction and the sub scanning direction, the present invention can provide a droplet discharge drawing apparatus that can discharge a droplet, at a high precision of landing of the droplet, to a desired point on a large-size target recording material.

The droplet discharge drawing program of the present invention preferably causes the control means to function as means that supplies the oscillation signal to the pre-oscillation means, while the displacement means moves the droplet discharging means from a position where a droplet is previously discharged to a position which allows a droplet to be discharged next to a target of discharge, the oscillation signal being for causing the pre-oscillation of the droplet discharging means.

The pre-oscillation of the droplet discharging means is carried out during movement of the droplet discharging means between targets of discharge. This can provide a droplet discharge drawing apparatus that can prevent an increase in viscosity of the droplet during the movement.

The droplet discharge drawing program of the present invention preferably causes the control means to function as means that supplies the oscillation signal to the pre-oscillation means, before the droplet discharging means first reaches a position allowing a droplet to be discharged on a target of discharge after the droplet discharging means starts to move in the step of moving, the oscillation signal being for causing the pre-oscillation of the droplet discharging means.

After the droplet discharging means starts to move, pre-oscillation is carried out before the droplet discharging means first discharges the ink. This further provides an advantage such that an increase in viscosity of the ink can be prevented in the first movement.

The droplet discharge drawing program of the present invention preferably causes the control means to function as means that supplies, to the pre-oscillation means, the oscillation signal for causing the pre-oscillation of the droplet discharging means, the pre-oscillation signal indicating (i) a number of times of oscillation in the pre-oscillation in a range of not less than 1000 but not more than 10000 and (ii) a period for one time of the oscillation in a range of 0.000005 second to 0.0001 second.

Because the pre-oscillation of the droplet discharging means is carried out the number of times of oscillation and at the period of the oscillation as described above, it becomes possible to sufficiently prevent an increase in viscosity of the droplet during the movement of the droplet discharging means. Therefore, clogging of a nozzle or the like is prevented and, in addition, an improved precision of landing of the droplet can be obtained.

The droplet discharge drawing program preferably causes the control means to function as means that changes a pre-oscillation time required for carrying out the pre-oscillation, in accordance with at least one of: a movement time required, in the step of moving, for moving the droplet discharging means to a position which first allows the droplet discharging means to discharge a droplet to a target of discharge, after the droplet discharging means starts to move; and a movement time required, in the step of moving, for moving the droplet discharging means from a position where a droplet is previously discharged to a position where a droplet is to be discharged next to another target of discharge.

Because the pre-oscillation time can be varied, timing of the pre-oscillation of the droplet discharging means can be controlled by a desired condition. This can make it possible to provide a droplet discharge drawing apparatus capable of providing a desired precision of landing of the droplet.

According to the droplet discharge drawing program of the present invention, in a case where the droplet discharge drawing apparatus further includes pre-oscillation condition input means through which an oscillation condition is inputted for the pre-oscillation that the droplet discharging means is caused to carry out, the droplet discharge drawing program causes the control means to function as: means calculating at least one of: a movement time required for moving the droplet discharging means to a position which first allows the droplet discharging means to discharge a droplet to a target of discharge, after the displacement means starts to move the droplet discharging means; and a movement time required for moving the droplet discharging means from a position where a droplet is previously discharged to a position where a droplet is to be discharged next to another target of discharge; and means calculating a pre-oscillation time required for allowing the droplet discharging means to carry out the pre-oscillation that satisfies the oscillation condition.

Because it is possible to precisely figure out the movement time and pre-oscillation time of the droplet discharging means, pre-oscillation of the droplet discharging means can be carried out under a desired condition based on the movement time and pre-oscillation time. This makes it possible to set a desired precision of landing of the droplet depending on a purpose.

According to the droplet discharge drawing program of the present invention, if the movement time calculated for the droplet discharging means is longer than twice the pre-oscillation time calculated for the droplet discharging means, the droplet discharge drawing program preferably causes the control means to function as means that supplies the pre-oscillation signal to the pre-oscillation means so that, when a period equal to a half of the movement time passes after start of the movement time, the droplet discharging means starts the pre-oscillation, the pre-oscillation signal being for causing the pre-oscillation of the droplet discharging means.

The pre-oscillation of the droplet discharging means is carried out in a latter half of the movement before the discharge of the droplet. Accordingly, the droplet can be discharged after the problem of the increase in viscosity of the droplet caused in movement before the pre-oscillation is resolved. This can further provides effects such that clogging of a nozzle or the like is more effectively prevented and the droplet is discharged at a higher precision of landing of the droplet.

According to the droplet discharge drawing program of the present invention, if the movement time calculated for the droplet discharging means is longer than the pre-oscillation time calculated for the droplet discharging means, the droplet discharge drawing program preferably causes the control means to function as means that supplies the pre-oscillation signal to the pre-oscillation means so that, at the time when the pre-oscillation time ends, the droplet discharging means starts discharge of a droplet, the pre-oscillation signal being for causing the pre-oscillation of the droplet discharging means.

Because the pre-oscillation of the droplet discharging means is carried out right before the discharge of the droplet, the droplet can be discharged after the problem of the increase in viscosity of the droplet caused in movement before the pre-oscillation is resolved. This can further provides effects such that clogging of a nozzle or the like is more effectively prevented and the droplet is discharged at a higher precision of landing of the droplet.

According to the droplet discharge drawing program of the present invention, in a case where, when the movement time calculated for the droplet discharging means is shorter than the pre-oscillation time calculated for the droplet discharging means, the pre-oscillation condition input means allows an input of the pre-oscillation time in a range of 1/10 to 1 times as long as the movement time, the pre-oscillation time being for the pre-oscillation that the droplet discharging means is caused to carry out, the droplet discharge drawing program preferably causes the control means to function as means that supplies, to the pre-oscillation means, the pre-oscillation signal in accordance with the setting.

A time of the actual pre-oscillation of the droplet discharging means is shortened so that the pre-oscillation can be carried out within the movement time. Accordingly, even when the droplet discharging means moves between targets of discharge close to each other, the pre-oscillation of the droplet discharging means can be carried out. This can further provides effects such that clogging of a nozzle or the like is more effectively prevented and the droplet is discharged at a higher precision of landing of the droplet.

According to the droplet discharge drawing program of the present invention, in a case where: at least one of the movement times calculated for the droplet discharging means is longer than the pre-oscillation time calculated for the droplet discharging means; and there is the movement time that is calculated for the droplet discharging means and shorter than the pre-oscillation time of the droplet discharging means, the droplet discharge drawing program causes the control means to function as means that does not supply the pre-oscillation signal to the pre-oscillation means so that the droplet discharging means that moves for the movement time shorter than the pre-oscillation time does not carry out the pre-oscillation.

If a desired pre-oscillation is impossible within the movement time, the pre-oscillation is omitted. This makes it possible to omit pre-oscillation that provides a less effect because the pre-oscillation time is too short. Therefore, by omitting a step providing a less effect, it becomes possible to carry out discharge of the droplet more effectively.

A droplet discharge drawing program of the present invention causes control means to function as means supplying an oscillation signal to pre-oscillation means so that pre-oscillation is carried out before discharge of droplets by a plurality of droplet discharging means and within a time in which displacement means relatively moves the plurality of droplet discharging means with respect to a target recording material, the plurality of droplet discharging means each being filled with a different kind of droplets, the pre-oscillation signal being for causing the pre-oscillation of the plurality of droplet discharging means, the control means supplying the pre-oscillation signal to the pre-oscillation means, the control means being provided in a droplet discharge drawing apparatus including: the plurality of droplet discharging means that discharges droplets with respect to a plurality of targets of discharge present on the target recording material; the displacement means that relatively moves the plurality of droplet discharging means with respect to the target recording material; and the pre-oscillation means that causes the pre-oscillation of the plurality of droplet discharging means.

According to the configuration, the pre-oscillation of each of the plurality of droplet discharging means can be carried out while a time when each of the plurality of droplet discharging means moves. This makes it possible to provide a droplet discharge drawing program for controlling a droplet discharge drawing apparatus capable of discharging plurality droplets at a high precision of landing.

The droplet discharge drawing program of the present invention preferably causes the control means to function as means that supplies the pre-oscillation signal to each of the plurality of droplet discharging means so that the plurality of droplet discharging means take an identical time from an end of the pre-oscillation carried out by each of the plurality of droplet discharging means to a start of discharge of a droplet by each of the plurality of droplet discharging means having carried out the pre-oscillation, the pre-oscillation signal being for causing the pre-oscillation of each of the plurality of droplet discharging means.

Because each droplet discharging means is arranged to have the same length of time from the pre-oscillation to discharge of the droplet, each droplet discharging means can provide the same precision of landing of the droplet. Therefore, it becomes possible to provide a droplet discharge drawing apparatus that does not cause a difference in precision of landing of droplet depending on types of droplets or the order of discharge and that has a steady precision of landing of droplet.

A droplet discharge drawing program of the present invention causes control means to function as means supplying an oscillation signal to pre-oscillation means so that pre-oscillation is carried out before discharge of droplets by droplet discharging means and within a time in which displacement means relatively moves the droplet discharging means with respect to a color filter panel for a liquid crystal display apparatus, the pre-oscillation signal being for causing the pre-oscillation of the droplet discharging means, the control means supplying the pre-oscillation signal to the pre-oscillation means, the control means being provided in a droplet discharge drawing apparatus including: the droplet discharging means that discharges droplets with respect to a plurality of defective pixels that occur on the color filter panel for the liquid crystal display apparatus; the displacement means that relatively moves the droplet discharging means with respect to the color filter panel for the liquid crystal display apparatus; and the pre-oscillation means that causes the pre-oscillation of the droplet discharging means.

This further makes it possible to provide a droplet discharge drawing program for controlling a droplet discharge drawing apparatus capable of producing a good quality color filter panel for a liquid crystal display apparatus by repairing defective pixels that occur on the color filter panel for the liquid crystal display apparatus.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating an arrangement of a substantial part of a defect repairing apparatus in accordance with an embodiment of the present invention.

FIG. 2 is a perspective view illustrating an appearance of the defect repairing apparatus in accordance with the embodiment of the present invention.

FIG. 3 is a cross-sectional view schematically illustrating a structure of a substantial part of an ink discharging unit included in the defect repairing apparatus illustrated in FIG. 2, where the ink discharging unit is cut through a predetermined position where an ink discharging section is provided and viewed in a Y direction shown in FIG. 2.

FIG. 4 is a bottom view schematically illustrating an arrangement of a substantial part of the ink discharging unit included in the defect repairing apparatus in accordance with the embodiment of the present invention.

FIG. 5 is a flow chart illustrating a procedure of a process for repairing a defect of a color filter substrate by using the defect repairing apparatus in accordance with the embodiment of the present invention.

FIG. 6 is a diagram schematically illustrating a relationship of (i) a state of movement of an ink discharging section included in the defect repairing apparatus in accordance with the embodiment of the present invention, (ii) timing of pre-oscillation; and (iii) timing of discharge of ink.

FIG. 7 is a diagram schematically illustrating how defective pixels on a color filter substrate are repaired by the ink discharging section.

FIG. 8 is a flow chart of a comparative example of the present invention, illustrating a procedure for carrying out pre-oscillation before main scanning movement and sub scanning movement of an ink discharging section in a process for repairing a defect of a color filter substrate by use of a defect repairing apparatus.

### REFERENCE SIGNS LIST

1 DEFECT REPAIRING APPARATUS (DROPLET DISCHARGE DRAWING APPARATUS)
2 INK DISCHARGING UNIT
3R, 3B, 3G INK DISCHARGING SECTION (DROPLET DISCHARGING MEANS)
4 HEAD GANTRY UNIT
5 GANTRY SLIDING MECHANISM (DISPLACEMENT MEANS)
6R, 6B, 6G PRE-OSCILLATION SECTION (PRE-OSCILLATION MEANS)
7 COMPUTER
8 CONTROL SECTION (CONTROL MEANS)
9 PRE-OSCILLATION CONDITION INPUT SECTION (PRE-OSCILLATION CONDITION INPUT MEANS)
100 COLOR FILTER SUBSTRATE (TARGET RECORDING MATERIAL)
101R, 101B, 101G DEFECTIVE PIXEL (TARGET OF DISCHARGE)

### DESCRIPTION OF EMBODIMENTS

### Embodiment

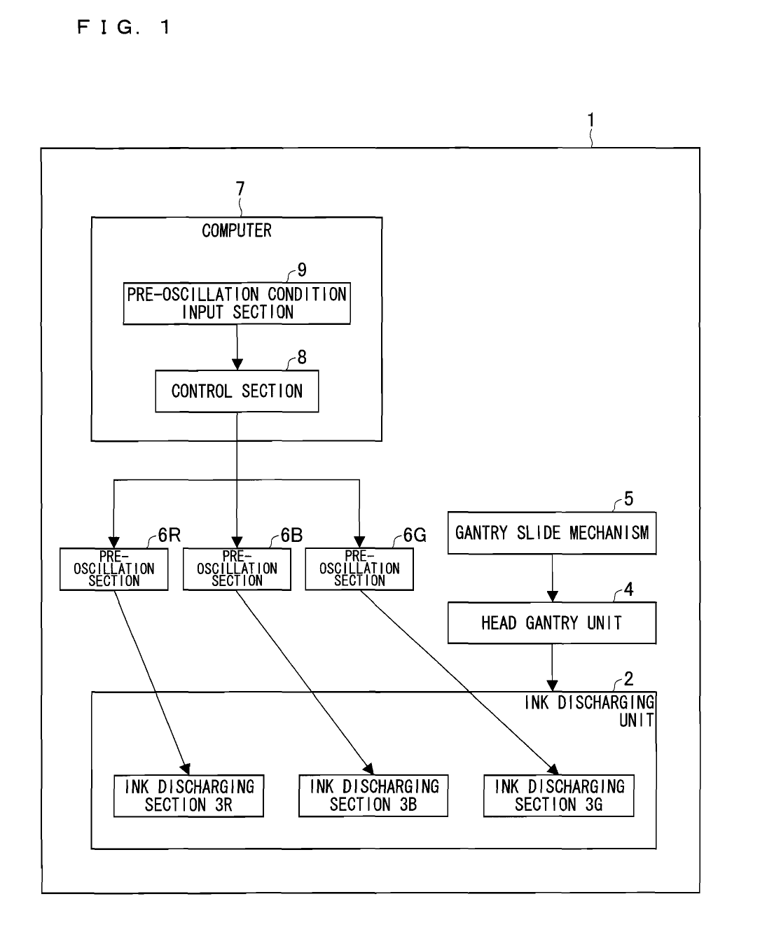

The following description deals with one embodiment of the present invention with reference to FIGS. 1 through 7.

<Arrangement of Substantial Part of Defect Repairing Apparatus 1>

First, the following description deals with an arrangement of a substantial part of a defect repairing apparatus 1 in accordance with the present embodiment with reference to FIG. 1.

FIG. 1 is a block diagram illustrating an arrangement of a substantial part of the defect repairing apparatus 1 (droplet discharge drawing apparatus). As illustrated in FIG. 1, the defect repairing apparatus 1 includes an ink discharging unit 2, a head gantry unit 4, a gantry sliding mechanism 5 (displacement means), pre-oscillation sections 6R, 6B, and 6G (pre-oscillation means), and a computer 7.

The ink discharging unit 2 includes an ink discharging section 3R for red (R) ink, an ink discharging section 3G for green (G) ink, and an ink discharging section 3B for blue (B) ink.

The ink discharging unit 2 moves by sliding on the head gantry unit 4. Therefore, it is possible for the ink discharging unit 2 to move in a sub scanning direction with respect to a color filter substrate (not illustrated) which is a target of defect repair. Further, the gantry sliding mechanism 5 allows, via the head gantry unit 4, the ink discharging unit 2 to move in a main scanning direction above the color filter substrate which is the target of the defect repair. Such movement is described in detail later.

The computer 7 includes a control section 8 (control means) and a pre-oscillation condition input section 9 (pre-oscillation condition input means).

A desired pre-oscillation condition can be inputted into the pre-oscillation condition input section 9. The pre-oscillation condition to be inputted is not particularly limited, and may be set in accordance with, for example, a color filter substrate which is a target to be repaired. However, it is preferable to set the number of times of oscillation in one pre-oscillation (hereinafter, referred to as “the number of times of pre-oscillation”, for convenience of explanation) in a range of not less than 1000 times but not more than 10000 times, and more preferably 6000 times. Further, it is preferable to set a period of the oscillation in a range of not less than 0.000005 second but not more than 0.0001 second, and more preferably 0.00001 second. In other words, it is preferable to set a frequency in a range of not less than 10 kHz but not more than 200 kHz, and more preferably 100 kHz. In the present embodiment, a case where the number of times of pre-oscillation is 6000 times and the period is 0.00001 second is explained below.

It should be noted that, in the present embodiment, the “pre-oscillation” means meniscus oscillation of droplets with which droplet discharging means is filled. This meniscus oscillation is caused according to a head drive waveform signal that is provided to the droplet discharging means and that is not a signal for discharging droplets. The pre-oscillation is provided for the purpose of inhibiting an increase in viscosity of the droplets with which the droplet discharging means is filled. Further, the “one pre-oscillation” means pre-oscillation that occurs according to an oscillation signal supplied at a time.

Furthermore, it is also possible to input, via the pre-oscillation condition input section 9, a condition of a case where pre-oscillation that satisfies a desired pre-oscillation condition cannot be carried out during the movement between preceding discharge of ink by the ink discharging sections 3R, 3B, and 3G and subsequent discharge of ink by the ink discharging sections 3R, 3B, and 3G. Details of such conditions will be explained later, however, for example, in a case where a desired pre-oscillation time cannot be ensured, it is possible input a setting to reduce an actual pre-oscillation time or to omit the pre-oscillation.

Based on the pre-oscillation condition, the control section 8 creates oscillation signals which are necessary for causing the respective ink discharging sections 3R, 3B, and 3G to carry out the pre-oscillation satisfying the pre-oscillation condition, and then supplies pre-oscillation sections 6R, 6B, and 6G with the oscillation signals, respectively.

Having been supplied with the oscillation signals independently from the computer 7, The pre-oscillation sections 6R, 6B, and 6G cause, in accordance with the respective oscillation signals, the respective ink discharging sections 3R, 3B, and 3G to carry out the pre-oscillation.

Further, the control section 8 calculates, based on a discharging pattern (which will be described later), a movement time in which the ink discharging sections 3R, 3B, and 3G moves from a position where the ink discharging sections have discharged ink to a next position that allows the ink discharging sections to discharge ink to a next target of discharge of ink. Furthermore, when calculating the oscillation signals, the control section 8 simultaneously calculates a pre-oscillation time which is necessary for carrying out the pre-oscillation satisfying the pre-oscillation condition. The control section 8 is configured so as to, in accordance with the pre-oscillation time and the movement time, change (i) timing at which the actual pre-oscillation is started, and/or (ii) the actual pre-oscillation time. This makes it possible to carry out, for example, the condition in the case where the pre-oscillation satisfying the desired pre-oscillation condition cannot be carried out as described above.

Here, in the present specification, the “pre-oscillation time” means a period which is necessary for carrying out pre-oscillation, and can be calculated by use of the following formula (1), for example.

Pre-oscillation time=(the number of times of pre-oscillation×period of oscillation)+α (1)

In the formula (1), “α” indicates a time from an end of a last oscillation of the pre-oscillation to a start of discharge of ink by the ink discharging section. This time is required depending on a specification of the apparatus or the like. For example, the time includes a period from a time the pre-oscillation ends to a time the end of the pre-oscillation is recognized by a control system for controlling the process for repairing defect.

<Structure of Defect Repairing Apparatus 1>

(Structure of Whole Defect Repairing Apparatus 1)

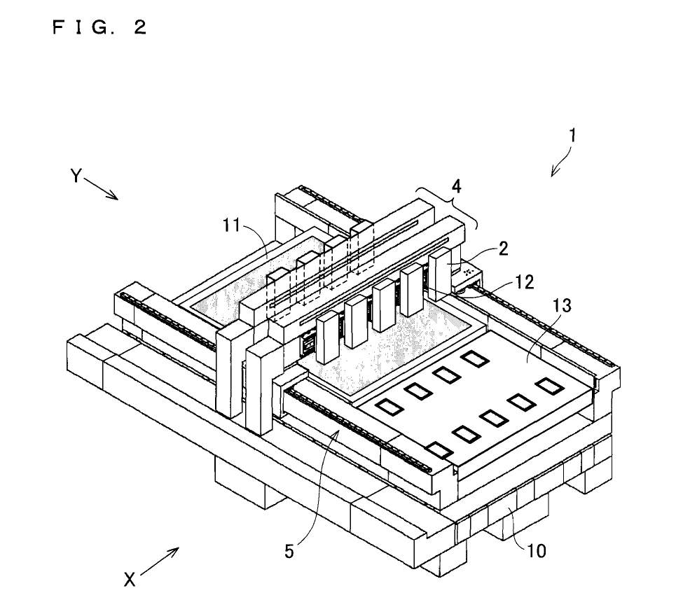

Next, the following description deals with a structure of the defect repairing apparatus 1 with reference to FIG. 2. FIG. 2 is a perspective view illustrating an appearance of the defect repairing apparatus 1.

As illustrated in FIG. 2, the defect repairing apparatus 1 includes a substratum 10. The substratum 10 includes a color filter substrate mounting table 11 which is moved when a color filter substrate (target recording material, not illustrated) is carried in/out of the defect repairing apparatus 1. The head gantry unit 4 is provided in the defect repairing apparatus 1 so that the head gantry unit 4 is not in contact with the color filter substrate mounting table 11 but crosses the color filter substrate mounting table 11.

The gantry sliding mechanism 5 that is connected to the substratum 10 allows the head gantry unit 4 to move back and forth in a direction parallel to a direction Y shown in FIG. 2.

The gantry sliding mechanism 5 allows the head gantry unit 4 to move so that the ink discharging sections 3R, 3B, and 3G move at a constant speed in a main scanning direction (the direction parallel to the Y direction shown in FIG. 2) relatively with respect to a glass substrate placed on the color filter substrate mounting table 11. It should be noted that this movement in the main scanning direction is hereinafter simply referred to as “main scanning movement”.

The color filter substrate mounting table 11 can also move back and forth along the direction parallel to the Y direction shown in FIG. 2, so as to carry a color filter substrate into/out of the defect repairing apparatus 1.

Further, the defect repairing apparatus 1 includes a plurality of ink discharging units 2. Each of the plurality of ink discharging units 2 is provided to a side surface of the head gantry unit 4 via a discharging unit sliding mechanism 12. The plurality of ink discharging units 2 are arranged such that each of the plurality of ink discharging units 2 can move back and forth independently in a direction parallel to an X direction shown in FIG. 2. The discharging unit sliding mechanism 12 allows the ink discharging unit 2 to move back and forth so that the ink discharging sections 3R, 3B, and 3G (described later) can move in a sub scanning direction (the direction parallel to the X direction indicated in FIG. 2) relatively with respect to the grass substrate placed on the color filter substrate mounting table 11. It should be noted that this movement in the sub scanning direction is hereinafter simply referred to as a “sub scanning movement”.

In addition to the color filter substrate mounting table 11, a maintenance mechanism 13 is provided, on the substratum 10, for the ink discharging sections 3R, 3G, and 3B. The maintenance mechanism 13 includes mechanisms such as: a mechanism for capping, when nozzles are not in operation, a surface on which the nozzles are provided; a mechanism for detecting a defective discharging nozzle; a mechanism for repairing a defective discharging nozzle. For the maintenance of the ink discharging sections 3R, 3G and 3B, the gantry sliding mechanism 5 moves the head gantry unit 4 to right above the maintenance mechanism 13, and various maintenance operations are carried out with respect to the ink discharging units 2.

(Structure of Ink Discharging Unit 2)

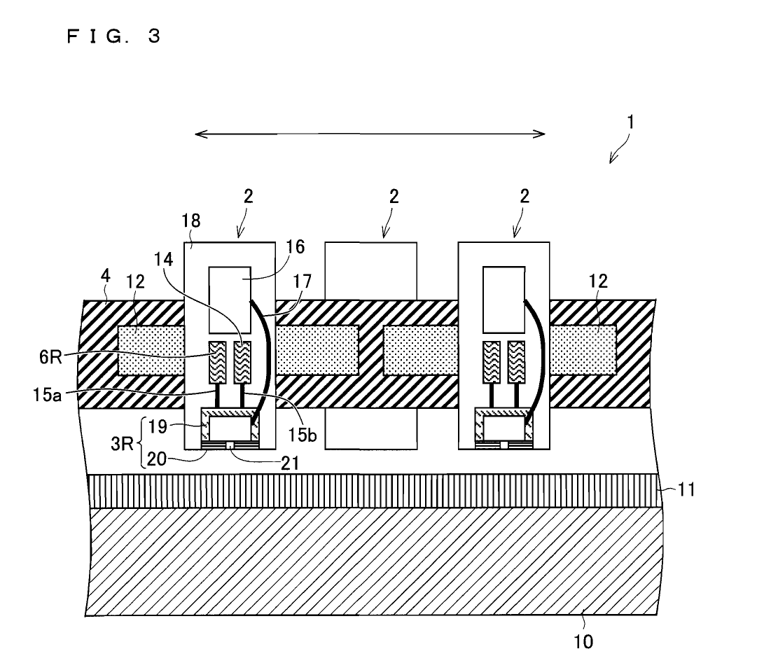

Next, the following description deals with details of a structure of the ink discharging unit 2 with reference to FIG. 3. FIG. 3 is a cross-sectional view schematically illustrating a structure of a substantial part of the ink discharging unit 2. FIG. 3 is a view when the ink discharging unit 2 is cut through a predetermined position where the ink discharging section 3R is provided, and viewed from the Y direction indicated in FIG. 2.

As illustrated in FIG. 3, the ink discharging units 2 are provided to the discharging unit sliding mechanism 12 provided on the head gantry unit 4, and each of the ink discharging units 2 can move independently in a direction indicated by arrows shown in FIG. 3.

Further, the ink discharging unit 2 includes: the ink discharging sections 3R, 3B (not illustrated), and 3G (not illustrated); the pre-oscillation section 6R; a discharge control circuit 14; an electrical connection cables 15a and 15b; an ink tank 16; an ink pipe 17; and a housing 18 containing these. The housing 18 slides on the discharging unit sliding mechanism 12.

The ink discharging section 3R includes a discharging element 19 and a nozzle plate 20. The nozzle plate 20 is bonded to a surface of the discharging element 19 which surface faces the color filter substrate mounting table 11.

Furthermore, the nozzle plate 20 has a plurality of nozzle holes 21. A diameter of the nozzle hole 21 is in a range from 15 μm to 25 μm. The nozzle holes 21 are formed so as to face the color filter substrate mounting table 11, and ink is discharged from the nozzle holes 21 onto a color filter substrate (not illustrated) (the target to be repaired) provided on the color filter substrate mounting table 11.

As the discharging element 19, a publicly-known arrangement is used. The arrangement is such that (i) after a plurality of grooves which become ink chambers are formed on a piezoelectric substrate, an electrode is formed on a part of side surfaces of a partition wall and (ii) an electric field is applied to between the side surfaces of the partition wall so that the partition wall itself is shear-deformed and a discharge energy is generated.

The nozzle plate 20 is adjusted in advance so that, when the color filter substrate which is the target to be repaired is provided on the color filter substrate mounting table 11, a space between a lower surface of the nozzle plate 20 and an upper surface of the color filter substrate is in a range from 0.5 mm to 1 mm.

The pre-oscillation section 6R is connected to the computer 7 via a cable (not illustrated), and causes, via an electric connection cable 15a, the ink discharging section 3R to carry out pre-oscillation in accordance with the oscillation signal received from the control section 8.

The discharge control circuit 14 is connected to a drive control system (not illustrated) via a cable (not illustrated), and controls the discharge of ink.

(Structure of Nozzle Holes 21 Formed in Ink Discharging Sections 3R, 3B, and 3G).

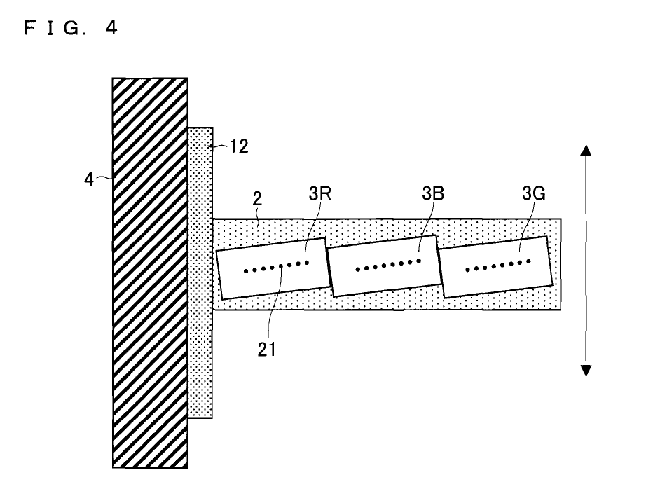

Next, the following description deals with a structure of the nozzle holes 21 formed in the ink discharging sections 3R, 3B, and 3G with reference to FIG. 4. FIG. 4 is a bottom view schematically illustrating an arrangement of a main part of the ink discharging unit 2.

As illustrated in FIG. 4, the ink discharging sections 3R, 3G, and 3B have the nozzle holes 21. The nozzle holes 21 are provided in lines that are inclined at some degrees with respect to a direction orthogonal to a direction (the X direction shown in FIG. 2) indicated by arrows shown in FIG. 4. The lines are arranged so that projection regions of the respective lines in the direction indicated by the arrows shown in FIG. 4 are substantially identical.

If the lines of the nozzle holes are inclined at θ with respect to the direction orthogonal to the direction indicated by the arrows shown in FIG. 4 and a nozzle hole pitch is p, a nozzle hole pitch Q which is obtained by projecting the nozzle hole pitch in the direction indicated by the arrows can be expressed by the following formula.

Q=p×sin θ

Therefore, there is an advantage such that the nozzle holes 21 can have the nozzle hole pitch Q in the X direction at a density that is higher than that of an actual nozzle hole pitch. The nozzle pitch Q having a higher density makes it possible that, in a case where one unit is manufactured by a combination of a plurality of heads, each head can be aligned to have at the lowest an accuracy of the nozzle hole pitch Q even when each position of the heads has not been precisely adjusted.

It is preferable that each discharging element 19 has 20 to 80 nozzle holes at a nozzle pitch in a range from 100 DPI to 200 DPI (100 to 200 holes are aligned at a constant pitch in a width of 1 inch) and the discharging element itself is inclined at θ (θ=3° to 10°). This is because the smaller the number of nozzle holes 21 that one discharging element 19 has becomes, the shorter a width of the entire ink discharging unit 2 in which a plurality of elements are aligned becomes, and, accordingly, a region to which the ink discharging unit 2 cannot discharge ink becomes smaller. Further, by inclining, at θ (θ=3° to 10°), a 100 DPI to 200 DPI discharging element that is reasonable in manufacturing cost, it becomes possible to have an advantage described below. That is, even if each of the plurality of discharging elements is not precisely aligned, the nozzle hole pitch projected in the direction indicated by the arrows shown in FIG. 4 can have a high density in a range from 5 μm to 35 μm, by carrying out once a test discharge and discharge timing control. In other words, the droplets of ink discharged can be provided at a higher density than a pixel size of a color filter, a pixel size of an organic EL display apparatus, or the like.

<Operation Flow of Defect Repairing Device 1>

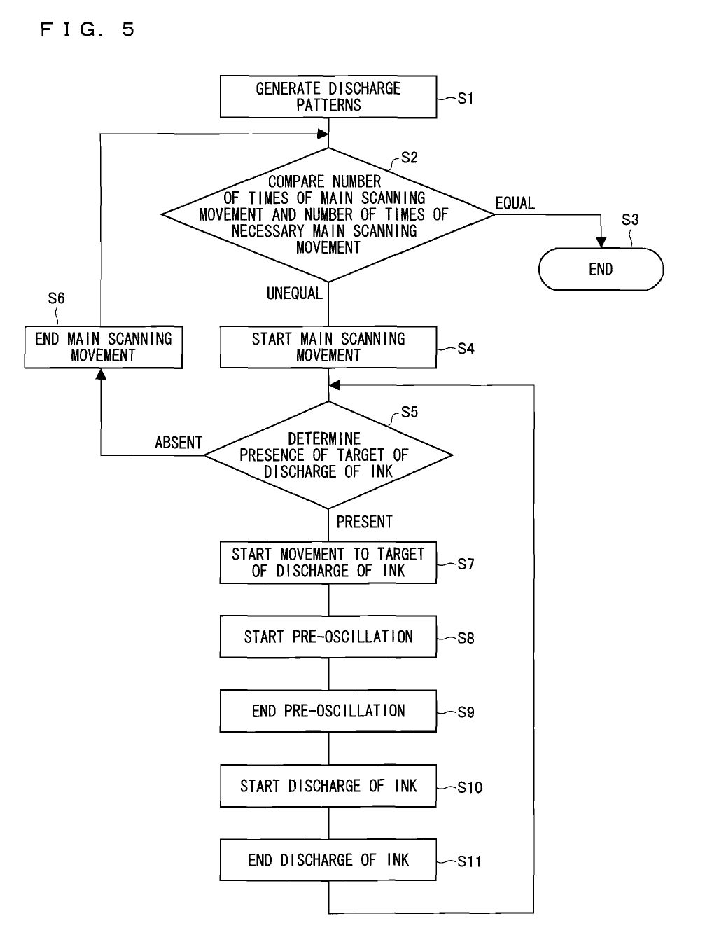

Next, with reference to FIG. 5, how the defect repairing device 1 operates is described as follows. FIG. 5 is a flowchart illustrating a procedure of a process for repairing defects on the color filter substrate by using the defect repairing device 1.

As illustrated in FIG. 5, first, in accordance with the number and positions of defective pixels (targets of discharge) which are located on the color filter substrate and are to be repaired, discharge patterns of the ink discharging sections 3R, 3G, and 3B are generated (Step 1). The discharge patterns include, for example, the number of times of the necessary main scanning movement, timing of the sub scanning movement, timing of the discharge of ink which are required in discharging ink to all the defective pixels.

Here, the number of times of the main scanning movement denotes the number of times the head gantry unit 4 scans in the main scanning direction above the color filter substrate. That is, the main scanning movement is carried out at a constant speed and in a certain direction. A period from a start of the main scanning movement to an end of the movement in the certain direction is numbered as a single time. For example, if the direction is reversed and the main scanning movement is carried out thereafter, the main scanning movement after the reverse is numbered as the second time. Further, the number of times of the necessary main scanning movement denotes the number of times of the main scanning movement necessary for discharging ink to all the defective pixels.

Further, the discharge patterns are generated in accordance with a relationship of previously found positions of the defective pixels. That is, in the defect repairing device 1, once the ink discharging sections 3R, 3G, and 3B start the main scanning movement, the ink discharging sections 3R, 3G, and 3B keep on moving in a certain direction (main scanning direction) and at a constant speed, and there is no change in the speed as long as the main scanning movement is not stopped. Thus, even if the ink discharging sections 3R, 3G, and 3B can carry out sub scanning movement, the sub scanning movement may not be carried out in time in case where two defective pixels are positioned close to each other in the main scanning direction and are positioned away from each other in the sub scanning direction for example. This is because the main scanning movement is continued at the constant speed. Therefore, in such a case, it is necessary to repair one defective pixel, and then to pass over the other defective pixel and end the main scanning movement, and further to start the main scanning movement in a main scanning direction opposite to the foregoing main scanning direction.

Thus, the discharge patterns are generated in accordance with the previously found positions of the defective pixels, the speed of the main scanning movement, and the speed of the sub scanning movement so that the number of times the main scanning movement is ended is as small as possible. Specifically, an order of discharge of ink onto targets is calculated so that the number of times of the main scanning movement carried out by the head gantry unit 4 is as small as possible, and the discharge patterns are generated in accordance with a movement time required in reaching a position which allows ink to be discharged to the defective pixel calculated on the basis of the aforementioned order.

It may be so arranged that the defect repairing device 1 internally includes calculation means such as a computer or the like so as to generate the discharge patterns, or it may be so arranged that the discharge patterns are generated by a computer 7.

After Step 1, the number of times of the main scanning movement that has been carried out is calculated, and the calculated number is compared with the number of times of the necessary main scanning movement (Step 2). If the number of times of the main scanning movement that has been carried out is equal to the number of times of the necessary main scanning movement, the process for repairing the defect on the color filter substrate is ended (Step 3). If the number of times of the main scanning movement that has been carried out is not equal to the number of times of the necessary main scanning movement, the main scanning movement is started (Step 4).

Next, it is judged whether or not there is any target of discharge (defective pixel) to which ink should be discharged during the main scanning movement started in Step 4 (Step 5).

In case where it is judged that there is no target of discharge in Step 5, the main scanning movement is ended (Step 6) and the process returns to Step 2.

In case where it is judged that there is a target of discharge in Step 5, there is started movement of the ink discharging sections 3R, 3G, and 3B to the position which allows ink to be discharged to the target of discharge (Step 7). At this time, sub scanning movement is suitably carried out in accordance with the discharge patterns.

After starting the movement, the ink discharging sections 3R, 3G, and 3B start pre-oscillation before each ink discharging section reaches the position which allows ink to be discharged to the target of discharge (Step 8). In Step 8, in accordance with an oscillation signal supplied from the control section 8 to pre-oscillation sections 6R, 6B, and 6G, an ink-discharging section, required to carry out the pre-oscillation, out of the ink discharging sections 3R, 3G, and 3B starts the oscillation. After the pre-oscillation is ended (Step 9), the ink-discharging section having carried out the pre-oscillation starts discharge of ink (Step 10). Further, after the discharge of ink is ended (Step 11), the process returns to Step 5.

Note that, the foregoing description explained the case where the main scanning movement is first started and then each of the ink discharging sections 3R, 3G, and 3B is moved to the target of discharge while suitably carrying out the sub scanning movement, but it may be so arranged that the main scanning movement is started after previously carrying out the sub scanning movement according to a position of the target of discharge. In this case, during the processes from Step 2 to Step 4, there may be added such a step that: whether or not there is any target of discharge is judged, and a position of the target is confirmed, and then the ink discharging sections 3R, 3G, and 3B are caused to preliminary carry out sub scanning movement in accordance with a speed of the main scanning movement and a speed of the sub scanning movement.

The control of the entire defect repairing process which was described above may be such that calculation means such as a computer is provided in the defect repairing device 1 so as to carry out the control. Further, the computer 7 may serve as the computer of the calculation means.

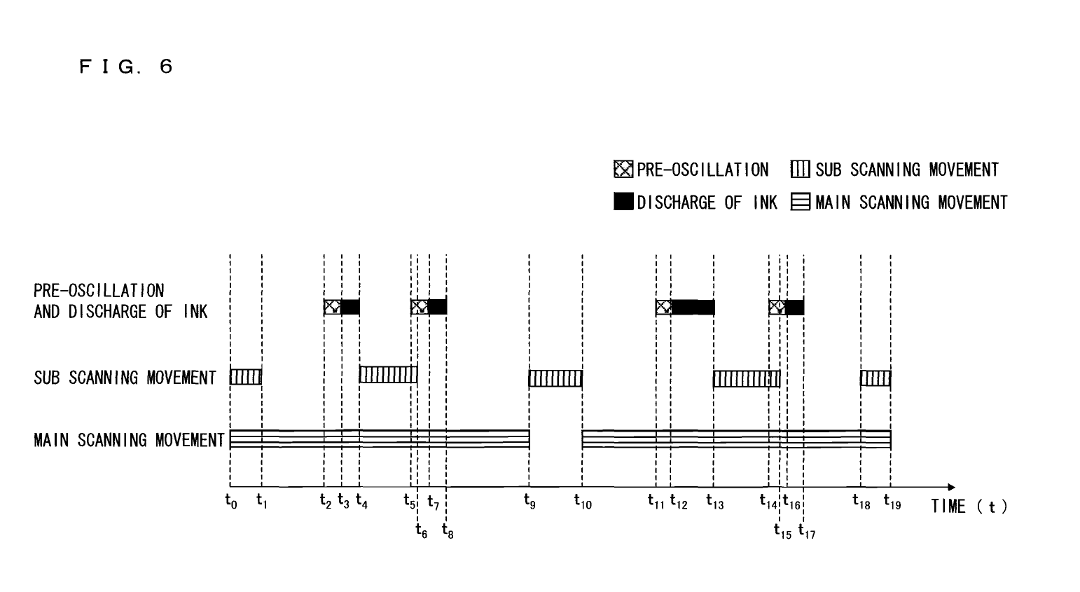

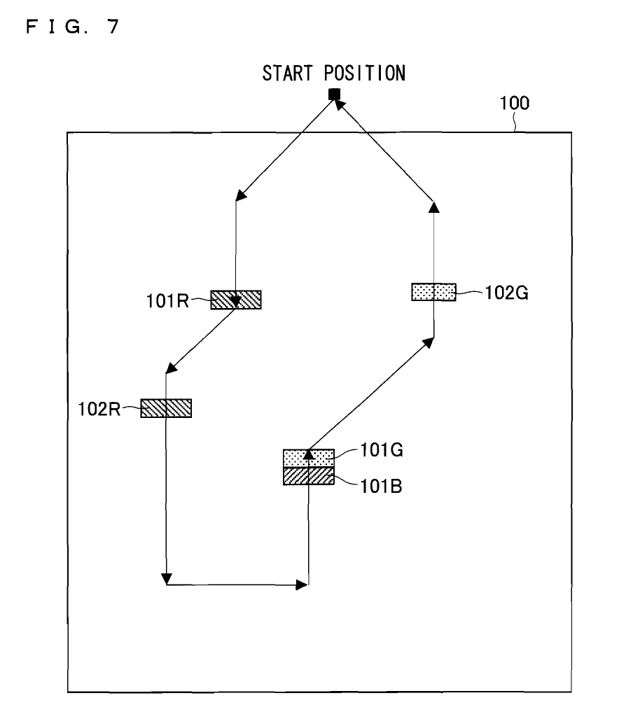

Next, with reference to FIG. 6 and FIG. 7, the following further details a relationship of (i) movement of the ink discharging sections 3R, 3G, and 3B, (ii) timing of the pre-oscillation, and (iii) timing of the discharge of ink.

FIG. 6, showing the present embodiment, is a schematic illustrating the relationship of (i) the movement of the ink discharging sections 3R, 3G, and 3B, (ii) the timing of the pre-oscillation, and (iii) the timing of the discharge of ink. In FIG. 6, a horizontal axis represents a flow of time.

FIG. 7 is a schematic illustrating a state in which defective pixels on the color filter substrate 100 are repaired by the ink discharging sections 3R, 3G, and 3B. FIG. 6 and FIG. 7 correspond to each other, and an arrow in FIG. 7 shows that the ink discharging unit 2 (ink discharging sections 3R, 3G, and 3B) moves above the color filter substrate 100 at the timing shown in FIG. 6. Further, each of times t0 to t19 shown in FIG. 6 indicates a time at which each operation described as follows is carried out.

As illustrated in FIG. 6 and FIG. 7, in the present embodiment, first, the ink discharging unit 2 starts main scanning movement and sub scanning movement, with respect to the color filter substrate 100, from a start position shown in FIG. 7 (t0). Next, the sub scanning movement ends at the time t1, and only the main scanning movement is carried out. Due to the sub scanning movement and the main scanning movement, the ink discharging section 3R moves toward a position which allows ink to be discharged to a defective pixel 101R.

Next, at the time t2, that is, before the ink discharging section 3R reaches the position which allows ink to be discharged to the defective pixel 101R, the pre-oscillation of the ink discharging section 3R is started. Further, at the same time as an end of the pre-oscillation at the time t3, the ink discharging section 3R starts to discharge ink to the defective pixel 101R. That is, it is controlled by the control section 8 that discharge of ink is started at the end of the pre-oscillation so that the ink discharging section discharging ink carries out the pre-oscillation right before the discharge.

At the same time as an end of the discharge at the time t4, the movement proceeds to movement for repairing a defective pixel 102R. At this time, as illustrated in FIG. 6 and FIG. 7, the ink discharging unit 2 starts main scanning movement and sub scanning movement at the time t4. Further, at the time t5 during the sub scanning movement, pre-oscillation of the ink discharging section 3R is started. In order to ensure a pre-oscillation time required in carrying out the pre-oscillation under a desired pre-oscillation condition, the pre-oscillation is started during the sub scanning movement. Further, the sub scanning movement ends at the time t6. Thereafter, at the time t7, the pre-oscillation ends, and at the same time, discharge of ink from the ink discharging section 3R to the defective pixel 102R is started. At the time t8, the discharge ends, and the ink discharging unit 2 continues the main scanning movement for a while, and then the main scanning movement ends at the time t9.

Next, the ink discharging unit 2 starts to move so that the ink discharging section 3G reaches a position which allows ink to be discharged to a defective pixel 101G and the ink discharging section 3B reaches a position which allows ink to be discharged to a defective pixel 101B. First, as illustrated in FIG. 6 and FIG. 7, sub scanning movement of the ink discharging unit 2 is started at the time t9, and at the same time as an end of the sub scanning movement at the time t10, second main scanning movement of the ink discharging unit 2 is started. At this time, a direction of the main scanning movement is reversed with respect to a direction of the first main scanning movement.

Next, pre-oscillations of the ink discharging sections 3G and 3B are started at the time t11. At the same time as ends of the pre-oscillations at the time t12, discharge of ink from the ink discharging section 3G to the defective pixel 101G and discharge of ink from the ink discharging section 3B to the defective pixel 101B are started. The discharge ends at the time t13, so that the defective pixels 101G and 101B are repaired.

Further, at the time t13, the ink discharging unit 2 starts sub scanning movement at the same time as an end of the discharge. Further, pre-oscillation of the ink discharging section 3G is started at the time t14 during the sub scanning movement. When the ink discharging unit 2 comes close to the defective pixel 102G, the sub scanning movement ends at the time t15, and only the main scanning movement is carried out. Thereafter, at the time t16, the ink discharging section 3G discharges ink to the defective pixel 102G. At the time t17, the discharge ends, so that the defective pixel 102G is repaired. In this manner, all the defective pixels on the color filter substrate 100 are repaired. Note that, thereafter, the ink discharging unit 2 starts sub scanning movement at the time t18 and carries out the main scanning movement and the sub scanning movement until the time t19, thereby returning to the start position shown in FIG. 7.

The present embodiment described the case of carrying out the pre-oscillation of the ink discharging section just before discharging ink. In this arrangement, an oscillation signal is supplied to the pre-oscillation sections 6R, 6B, and 6G as follows so as to control the pre-oscillation.

That is, there is calculated a movement time required in moving an ink discharging section out of the ink discharging sections 3R, 3G, and 3B, which discharges ink to a defective pixel to be repaired next, to a position which allows ink to be discharged to this defective pixel.

Besides, in accordance with a desired pre-oscillation condition inputted to a pre-oscillation condition input section 9, the control section 8 calculates in advance a pre-oscillation time required for carrying out pre-oscillation satisfying the desired pre-oscillation condition.

Further, the control section 8 compares the movement time with the pre-oscillation time. If the movement time is longer than the pre-oscillation time, the control section 8 supplies the oscillation signal to the pre-oscillation sections 6R, 6B, and 6G so that the ink discharging section starts discharge of ink when the pre-oscillation time ends. That is, the control section 8 is controlled so that the movement time ends at the same time as an end of the pre-oscillation time. For example, the control section 8 is controlled so that the oscillation signal is supplied when a time calculated by subtracting the pre-oscillation time from the movement time passes from the beginning of the movement time. Note that, in the present embodiment, the movement time is unexceptionally longer than the pre-oscillation time, so that it is possible to carry out the pre-oscillation just before the discharge of ink.

The present embodiment described the case of controlling so that the pre-oscillation is carried out just before the discharge of ink as described above. In this manner, it is preferable to carry out the pre-oscillation under a desired condition jut before the ink discharging section to be used discharges ink. However, each of the timing of the start of the pre-oscillation and the timing of the end of the pre-oscillation is not limited to the aforementioned timing. That is, the pre-oscillation time may be suitably changed in accordance with the movement time of the ink discharging section. The pre-oscillation time is controlled by the control section 8 so that a desired change is possible.

Specifically, also in the following case, it is possible to effectively inhibit viscosity of droplets from increasing during movement of the droplet discharging means.

It may be so controlled that: if the calculated movement time is longer than twice the calculated pre-oscillation time of the droplet discharging means, the droplet discharging means starts oscillation when a period equal to ½ of the movement time passes after start of the movement time.

That is, if the pre-oscillation is carried out at a latter half of the movement, it is possible to effectively inhibit viscosity of ink, with which each of the ink discharging sections 3R, 3G, and 3B is filled, from increasing before discharge of the ink.

Further, if the calculated movement time is shorter than the pre-oscillation time, that is, if it is difficult to ensure the desired pre-oscillation time during the movement between the defective pixels for such reason that the defective pixels are extremely close to each other or for a similar reason, the pre-oscillation time can be reduced.

For example, if the movement time is shorter than the pre-oscillation time, a time of actual pre-oscillation may be set to be equal to the movement time or to be shorter than the movement time, e.g., to be equal to 1/10 of the movement time. Note that, if the number of times of the pre-oscillation is small, less effect can be obtained, so that it is preferable to ensure the pre-oscillation time to some extent. For example, if 1000 or more times of pre-oscillation is given to the ink discharging sections 3R, 3G, and 3B so that a period of oscillation is in a range of 0.000005 or more seconds and 0.0001 or less seconds, it is possible to sufficiently inhibit viscosity of ink from increasing. Thus, for example, a time of actual pre-oscillation is set to be equal to or longer than 1/10 of the movement time. The specific setting is inputted to the pre-oscillation condition input section 9.

If it is difficult to sufficiently ensure the desired pre-oscillation during the movement time, the pre-oscillation may be omitted. Specifically, if the calculated movement time is shorter than the pre-oscillation time, the control section 8 having been set so as not to supply the oscillation signal can be used. For example, the control section 8 may be set so as not to supply the oscillation signal to the ink discharging sections 3R, 3G, and 3B if it is impossible to ensure the pre-oscillation time for carrying out the pre-oscillation having 6000 times of oscillation. However, the pre-oscillation has to be carried out once or more times as a result of the setting, so that this setting is effective only when a sufficient pre-oscillation time is ensured at least once. If a desired pre-oscillation time is not ensured at all, pre-oscillation is carried out at least once by the aforementioned method in which the pre-oscillation time is reduced.

Further, the setting for reducing the pre-oscillation time and the setting for omitting the pre-oscillation may be suitably combined with each other. That is, the pre-oscillation is set to have 6000 times of oscillation in principle. If the oscillation cannot be carried out 6000 times, a time of actual pre-oscillation is suitably controlled so as to be shorter. If 1000 times of oscillation cannot be carried out in the pre-oscillation, the pre-oscillation is omitted. The control section 8 may be set in this manner.

The pre-oscillation carried out may be only the first pre-oscillation. That is, the ink discharging section for discharging ink may carry out the pre-oscillation after starting main scanning movement and before discharging ink first. This is because it is possible to obtain effects such as improvement of precision of landing of droplets and a similar effect to some extent by preventing an increase in viscosity of ink which is caused by movement until the first discharge of ink is carried out.

Note that, as described above, the defect repairing device 1 can carry out the pre-oscillation also during the sub scanning movement of the ink discharging sections 3R, 3G, and 3B. The sub scanning movement of the ink discharging means indicates that the ink discharging means will discharge ink. Thus, the droplet discharge drawing apparatus arranged so that it is possible to carry out the pre-oscillation also during the sub scanning movement is advantageous in that the droplet discharging means having not discharged ink can carry out the pre-oscillation without fail.

The present embodiment describes the case where the ink discharging sections 3R, 3G, and 3B carry out the pre-oscillation just before discharging ink to each of a plurality of defective pixels. In this manner, it is preferable that each of the ink discharging sections 3R, 3G, and 3B carries out the pre-oscillation just before each ink discharging section is used to repair each defective pixel. With this arrangement, the respective ink discharging sections are the identical in view of a time period between the pre-oscillation and the discharge of ink, so that the precision of landing of droplets does not vary regardless of a color and/or an order in which the ink discharging sections discharge ink, thereby discharging ink with stable precision.

Lastly, each block of the control section 8, e.g., processings such as calculation of a pre-oscillation condition and supply of an oscillation signal may be realized with hardware logic, or may be realized with software using CPU as follows.

That is, the control section 8 includes: a CPU (central processing unit) which executes a control program realizing the functions; a ROM (read only memory) in which the program is stored; a RAM (random access memory) which develops the program; a storage device (storage medium) such as a memory in which the program and various kinds of data are stored; and the like. Further, the object of the present invention can be achieved as follows: a storage medium for computer-readably storing a program code (an execute form program, intermediate code program, or source program) of the control program of the control section 8 which is software for implementing the aforementioned functions is provided to the control section 8, and a computer (or CPU and MPU) reads out the program code stored in the storage medium so as to execute the program, thereby achieving the object of the present invention.

Examples of the storage medium which satisfies these conditions include: tapes, such as magnetic tape and cassette tape; disks including magnetic disks, such as floppy disks (registered trademark) and hard disk, and optical disks, such as CD-ROMs, magnetic optical disks (MOs), mini disks (MDs), digital video disks (DVDs), and CD-Rs; cards, such as IC cards (including memory cards) and optical cards; and semiconductor memories, such as mask ROMs, EPROMs, EEPROMs, and flash ROMs.

Further, the control section 8 may be arranged so that: the control section 8 is made connectable to communication networks, and the program code is supplied via the communication networks. The communication networks are not limited to a specific means. Specific examples of the communication network include Internet, intranet, extranet, LAN, ISDN, VAN, a CATV communication network, a virtual private network, a telephone line network, a mobile communication network, a satellite communication network, and the like. Further, a transmission medium constituting the communication network is not particularly limited. Specifically, it is possible to use a wired line such as a line in compliance with IEEE1394 standard, a USB line, a power line, a cable TV line, a telephone line, an ADSL line, and the like, as the transmission medium. Further, it is possible to use: a wireless line utilizing an infrared ray used in IrDA and a remote controller, a wireless line which is in compliance with Bluetooth standard (registered trademark) or IEEE802.11 wireless standard, and a wireless line utilizing HDR, a mobile phone network, a satellite line, a ground wave digital network, and the like, as the transmission medium. Note that, the present invention can be realized by a computer data signal which is realized by electronic transmission of the program code and which is embedded in a carrier wave.

### Comparative Example

The aforementioned arrangement in which the pre-oscillation is carried out with respect to the ink discharging sections 3R, 3G, and 3B during movement thereof and before reaching a position which allows ink to be discharged to a defective pixel to be repaired next is more advantageous in preventing viscosity of ink from increasing during the movement, as compared with an arrangement in which the pre-oscillation is carried out before the ink discharging sections 3R, 3G, and 3B start to move.

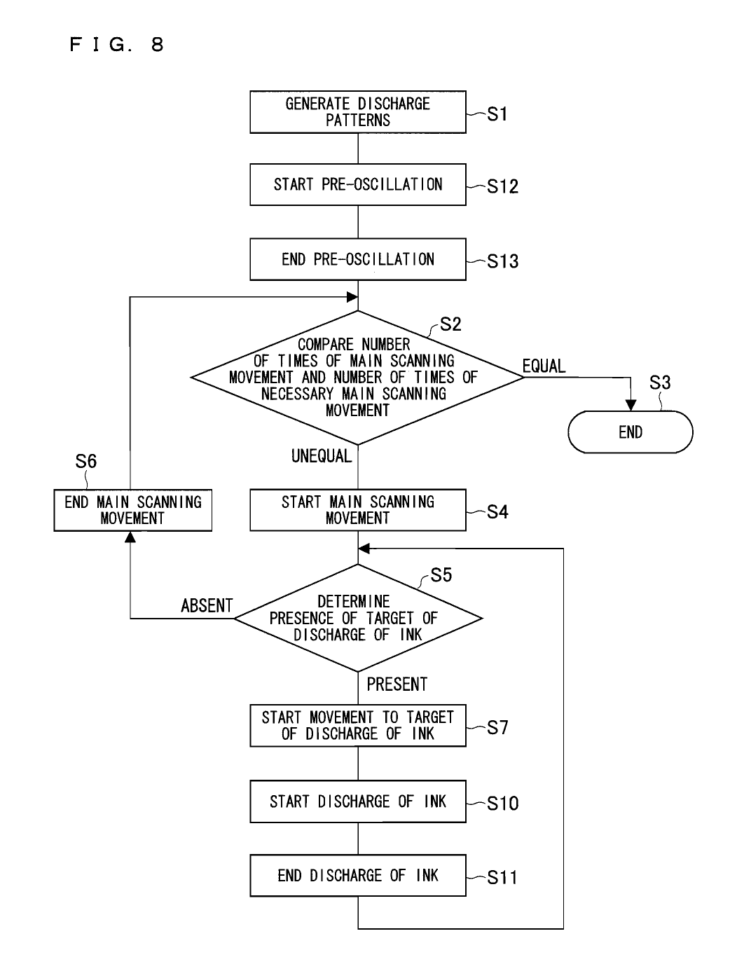

This point is explained as follows with reference to FIG. 8. FIG. 8 is a flowchart illustrating a procedure in case of carrying out the pre-oscillation before carrying out main scanning movement and sub scanning movement of the ink discharging sections 3R, 3G, and 3B in the process for repairing defects on the color filter substrate. Note that, for convenience in descriptions, the same numerals are given to steps similar to the steps according to the aforementioned embodiment, and descriptions thereof are omitted. In this Comparative Example, differences from the aforementioned embodiment are mainly described.

As illustrated in FIG. 8, the defect repairing process according to the present embodiment is such that: after Step 1, there is started pre-oscillation of all the ink discharging sections, used to repair the defects on the color filter substrate, out of the ink discharging sections 3R, 3G, and 3B (Step 12), and the pre-oscillation ends (Step 13) when there is carried out pre-oscillation satisfying a desired pre-oscillation condition having been inputted to the pre-oscillation input means in advance.

Thereafter, as in the aforementioned embodiment, the ink discharging sections 3R, 3G, and 3B discharge ink to the defective pixels on the color filter substrate while carrying out main scanning movement and sub scanning movement.

In this arrangement, there is no step of preventing viscosity of ink from increasing during the main scanning movement and the sub scanning movement.

Nozzle holes of the ink discharging sections 3R, 3G, and 3B are open during the main scanning movement and the sub scanning movement. Further, the defective pixels which are targets of discharge of ink are scattered about the color filter substrate. Thus, ink with which each of the ink discharging sections 3R, 3G, and 3B is filled moves a long distance with the ink exposed to the outside air. Therefore, the ink is likely to evaporate, so that viscosity of the ink increases. As a result, it is highly likely to result in clogging of the nozzle, so that it is not preferable to use this arrangement in the repair of defects which requires high precision of landing of ink.

On the other hand, if the pre-oscillation is carried out during the movement of the ink discharging sections 3R, 3G, and 3B as in the present embodiment, an increase in viscosity of ink can be inhibited during the movement, and clogging of the nozzle can be prevented, thereby realizing high precision of landing of ink.

The present invention is not limited to the description of the embodiments above, but may be altered by a skilled person within the scope of the claims. An embodiment based on a proper combination of technical means disclosed in different embodiments is encompassed in the technical scope of the present invention.

As described above, the droplet discharge drawing apparatus of the present invention further includes: control means supplying an oscillation signal to the pre-oscillation means so that the pre-oscillation is carried out before discharge of a droplet by the droplet discharging means and within a time in which the displacement means relatively moves the droplet discharging means with respect to the target recording material, the pre-oscillation signal being for causing the pre-oscillation of the pre-oscillation means. Thus, it is possible to provide a droplet discharge drawing apparatus, a droplet discharge drawing method, and a droplet discharge drawing program for controlling the droplet discharge drawing apparatus, according to each of which an increase in viscosity of droplets is inhibited during the movement of the droplet discharging means so that (i) clogging of the nozzle or the like hardly occurs even if the discharging means is moved at a high speed and (ii) droplets can be discharged to a desired point on the target recording material.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention makes it possible to discharge a droplet to a discharge target on a target recording material with high precision of landing of ink. Thus, the present invention is applicable not only to repair of a color filter substrate but also to various manufacture fields each of which requires a droplet to be efficiently discharged to a desired point.

1: A droplet discharge drawing apparatus comprising:
droplet discharging means that discharges droplets with respect to a plurality of targets of discharge present on a target recording material;
displacement means that relatively moves the droplet discharging means with respect to the target recording material;
pre-oscillation means that causes pre-oscillation of the droplet discharging means; and
control means supplying an oscillation signal to the pre-oscillation means so that the pre-oscillation is carried out before discharge of a droplet by the droplet discharging means and within a time in which the displacement means relatively moves the droplet discharging means with respect to the target recording material, the pre-oscillation signal being for causing the pre-oscillation of the pre-oscillation means.

2: The droplet discharge drawing apparatus as set forth in claim 1 wherein:
the displacement means relatively moves, at a constant speed in a main scanning direction, the droplet discharging means with respect to the target recording material; and
the droplet discharging means is movable in a sub scanning direction intersecting with the main scanning direction.

3: The droplet discharge drawing apparatus as set forth in claim 1 wherein:
the control means supplies the oscillation signal to the pre-oscillation means, while the displacement means moves the droplet discharging means from a position where a droplet is previously discharged to a position which allows a droplet to be discharged next to a target of discharge, the oscillation signal being for causing the pre-oscillation of the droplet discharging means.

4: The droplet discharge drawing apparatus as set forth in claim 1 wherein:
the control means supplies the oscillation signal to the pre-oscillation means, before the droplet discharging means first reaches a position allowing a droplet to be discharged on a target of discharge after the displacement means starts to move the droplet discharging means, the oscillation signal being for causing the pre-oscillation of the droplet discharging means.

5: The droplet discharge drawing apparatus as set forth in claim 1 wherein:
the control means supplies, to the pre-oscillation means, the oscillation signal for causing the pre-oscillation of the droplet discharging means, the pre-oscillation signal indicating (i) a number of times of oscillation in the pre-oscillation in a range of not less than 1000 but not more than 10000 and (ii) a period for one time of the oscillation in a range of 0.000005 second to 0.0001 second.

6: The droplet discharge drawing apparatus as set forth in claim 1 wherein:
the control means is capable of changing a pre-oscillation time required for carrying out the pre-oscillation, in accordance with at least one of:
a movement time required for moving the droplet discharging means to a position which first allows the droplet discharging means to discharge a droplet to a target of discharge, after the displacement means starts to move the droplet discharging means; and
a movement time required for moving the droplet discharging means from a position where a droplet is previously discharged to a position where a droplet is to be discharged next to another target of discharge.

7: The droplet discharge drawing apparatus as set forth in claim 1 further comprising:
pre-oscillation condition input means through which an oscillation condition is inputted for the pre-oscillation that the droplet discharging means is caused to carry out,
the control means calculating:
at least one of:
a movement time required for moving the droplet discharging means to a position which first allows the droplet discharging means to discharge a droplet to a target of discharge, after the displacement means starts to move the droplet discharging means; and
a movement time required for moving the droplet discharging means from a position where a droplet is previously discharged to a position where a droplet is to be discharged next to another target of discharge; and
a pre-oscillation time required for allowing the droplet discharging means to carry out the pre-oscillation that satisfies the oscillation condition.

8: The droplet discharge drawing apparatus as set forth in claim 7, wherein:
if the movement time calculated for the droplet discharging means is longer than twice the pre-oscillation time calculated for the droplet discharging means, the control means supplies the pre-oscillation signal to the pre-oscillation means so that, when a period equal to a half of the movement time passes after start of the movement time, the droplet discharging means starts the pre-oscillation, the pre-oscillation signal being for causing the pre-oscillation of the droplet discharging means.

9: The droplet discharge drawing apparatus as set forth in claim 7, wherein:
if the movement time calculated for the droplet discharging means is longer than the pre-oscillation time calculated for the droplet discharging means, the control means supplies the pre-oscillation signal to the pre-oscillation means so that, at the time when the pre-oscillation time ends, the droplet discharging means starts discharge of a droplet, the pre-oscillation signal being for causing the pre-oscillation of the droplet discharging means.

10: The droplet discharge drawing apparatus as set forth in claim 7, wherein:
when the movement time calculated for the droplet discharging means is shorter than the pre-oscillation time calculated for the droplet discharging means, the pre-oscillation condition input means allows an input of the pre-oscillation time in a range of 1/10 to 1 times as long as the movement time, the pre-oscillation time being for causing the pre-oscillation of the droplet discharging means; and
the control means supplies, to the pre-oscillation means, the pre-oscillation signal in accordance with the setting.

11: The droplet discharge drawing apparatus as set forth in claim 7, wherein:
in a case where:
at least one of the movement times calculated for the droplet discharging means is longer than the pre-oscillation time calculated for the droplet discharging means; and
there is the movement time that is calculated for the droplet discharging means and shorter than the pre-oscillation time of the droplet discharging means,
the control means does not supply the pre-oscillation signal to the pre-oscillation means so that the droplet discharging means that moves for the movement time shorter than the pre-oscillation time does not carry out the pre-oscillation.

12: The droplet discharge drawing apparatus as set forth in claim 1, further comprising:
a plurality of droplet discharging means each being filled with a different kind of droplets.

13: The droplet discharge drawing apparatus as set forth in claim 12, wherein:
the control means supplies the pre-oscillation signal to each of the plurality of droplet discharging means so that the plurality of droplet discharging means take an identical time from an end of the pre-oscillation carried out by each of the plurality of droplet discharging means to a start of discharge of a droplet by each of the plurality of droplet discharging means having carried out the pre-oscillation, the pre-oscillation signal being for causing the pre-oscillation of each of the plurality of droplet discharging means.

14: The droplet discharge drawing apparatus as set forth in claim 1, wherein:
the target recording material is a color filter panel for a liquid crystal display apparatus; and
the targets of discharge are defective pixels that occur on the color filter panel for the liquid crystal display apparatus.

15: A droplet discharge drawing method comprising the steps of:
discharging, by use of droplet discharging means, droplets with respect to a plurality of targets of discharge present on a target recording material;
relatively moving the droplet discharging means with respect to the target recording material;
causing, by use of pre-oscillation means, pre-oscillation of the droplet discharging means; and
controlling by supplying an oscillation signal to the pre-oscillation means so that the pre-oscillation is carried out before discharge of a droplet by the droplet discharging means and within a time in which the displacement means relatively moves the droplet discharging means with respect to the target recording material, the oscillation signal being for causing the pre-oscillation of the pre-oscillation means.

16-28. (canceled)

29: A droplet discharge drawing program causing control means to function as means supplying an oscillation signal to pre-oscillation means so that pre-oscillation is carried out before discharge of droplets by droplet discharging means and within a time in which displacement means relatively moves the droplet discharging means with respect to a target recording material,
the pre-oscillation signal being for causing the pre-oscillation of the droplet discharging means,
the control means supplying the pre-oscillation signal to the pre-oscillation means,
the control means being provided in a droplet discharge drawing apparatus including:
the droplet discharging means that discharges droplets with respect to a plurality of targets of discharge present on the target recording material;
the displacement means that relatively moves the droplet discharging means with respect to the target recording material; and
the pre-oscillation means that causes the pre-oscillation of the droplet discharging means.

30-42. (canceled)
